(19) United States
(12) Patent Application Publication
(10) Pub. No.: US 2004/0096079 A1
(43) Pub. Date: May 20, 2004

(54) Fastening device for earphone

(75) Inventors: Chang Ke Chang, Shulin City (TW); Wei Wen Sun, Panchiao City (TW)

Correspondence Address: BACON & THOMAS, PLLC, 625 SLATERS LANE, FOURTH FLOOR, ALEXANDRIA, VA, 22314

(73) Assignee: WANG WANG DAH ENTERPRISE CO., LTD., Panchiao City (TW)

(21) Appl. No.: 10/298,596

(22) Filed: Nov. 19, 2002

(51) Int. Cl. H04R 25/00; H04R 1/00

(52) U.S. Cl. 381/374; 381/385

(57) ABSTRACT

The present invention is to provide a fastening device formed at a cable of an earphone, the fastening device comprising a first half member and a second half member, both of the two members having a clipping end at one end, a holding end at the other end and a central hinge disposed therebetween with a shaft passing therethrough and a spring put on the shaft, the spring having both ends urged against the first half member and the second half member; wherein the first half member further comprises a recess for fitting a receiver of the earphone therein and a fastening element for securing the receiver in the recess.

### FIELD OF THE INVENTION

The present invention relates to fastening device for earphone and more particularly to such a fastening device with improved characteristics.

### BACKGROUND OF THE INVENTION

In recent years, along with the emergence of e-times, there has known a rapid, spectacular development in information technology leading to an increasing demand of resource accessing and information exchange on the Internet. As such, a variety of portable electronic devices (e.g., music players (e.g., Walkman™s), players complied with MP3 (Motion Picture Coding Expert Group Audio Layer-3), cellular phones, or the like) are developed and widely used in our daily life and all trades as an indispensable means.

It is typical to attach an earphone to the music player for listening to music or the cellular phone for achieving a hands-free purpose. There are two types of earphone commercially available. Namely, one is headphone held to the ears by a band over the head. It is disadvantageous for causing a degree of discomfort to the user (especially the ears) by clamping the head and the ears of the user. Also, it is not convenient to carry the headphone.

Another one is a plug typed earphone in which a receiver (e.g., speaker) thereof is inserted in the outer ear. Such earphone is gaining popularity recently. It is advantageous for being lightweight, portable, and compact. Also, a fastening device (e.g., clip) is typically formed at cable of the earphone to fasten the earphone for facilitating a user of music player or cellular phone to listen the earphone. In an unused state, the receiver of the earphone is fastened to the body of the user by the clip. Further, in a use state, the user can conveniently put the receiver in the ear in any time.

However, the plug typed earphone suffered from several disadvantages. For example, as stated above, in an unused state, the receiver of the earphone is fastened to the user by the clip. Hence, it is typical for the receiver and the cable of the earphone to fall and sway on the body of the user. This can cause inconvenience. Also, it is often that the user may be entangled by the cable and the receiver. In a worse case a thin conductor in the cable may be broken due to an inadvertent pulling. This can disconnect the cable. Moreover, it is messy and not aesthetic to have the cable and the receiver fallen and swayed on the user.

Thus, it is desirable by users and manufacturers of the earphone to provide an improved fastening device for earphone in order to overcome the above drawbacks (e.g., the cable and the receiver falling and swaying on the user) of the prior art.

### SUMMARY OF THE INVENTION

A primary object of the present invention is to provide a fastening device formed at a cable of an earphone including a receiver having an internal speaker at one end and a metal grille covered thereon, the cable being extended from the other end of the receiver to connect with the fastening device and then extended from the fastening device to form a jack at an open end thereof, the jack being connectable to an electronic device for receiving sound, the fastening device comprising a first half member including a clipping end at one end and a holding end at the other end; a coupled second half member including a clipping end at one end and a holding end at the other end; and both half members having a central hinge with a shaft passing therethrough and a spring put on the shaft, the spring having both ends urged against the first half member and the second half member; wherein the first half member further comprises a recess for fitting the receiver therein and a fastening element for securing the receiver in the recess. By utilizing this, it is possible of overcoming the above drawbacks (e.g., the cable and the receiver falling and swaying on the user in an unused state of the earphone, the thin conductor in the cable broken due to an inadvertent pulling, a disconnection of the cable, messy, and not aesthetic) of the prior art.

The above and other objects, features and advantages of the present invention will become apparent from the following detailed description taken with the accompanying drawings.

### BRIEF DESCRIPTION OF THE DRAWINGS

FIG. 1 is a perspective view of an earphone having a fastening device according to the invention;

FIG. 2 is an environmental view of the earphone in which the fastening device is inserted in the ear of user in a use state; and

FIG. 3 is similar to FIG. 2 in which the fastening device is placed in recess of the earphone in an unused state.

### DETAILED DESCRIPTION OF THE PREFERRED EMBODIMENTS

The invention is directed to a novel fastening device for earphone which is attached to the music player or the cellular phone. Most importantly, the invention can eliminate the drawbacks (e.g., the cable and the receiver falling and swaying on the user in an unused state of the earphone, the thin conductor in the cable broken due to an inadvertent pulling, a disconnection of the cable, and messy) of the prior art as detailed below.

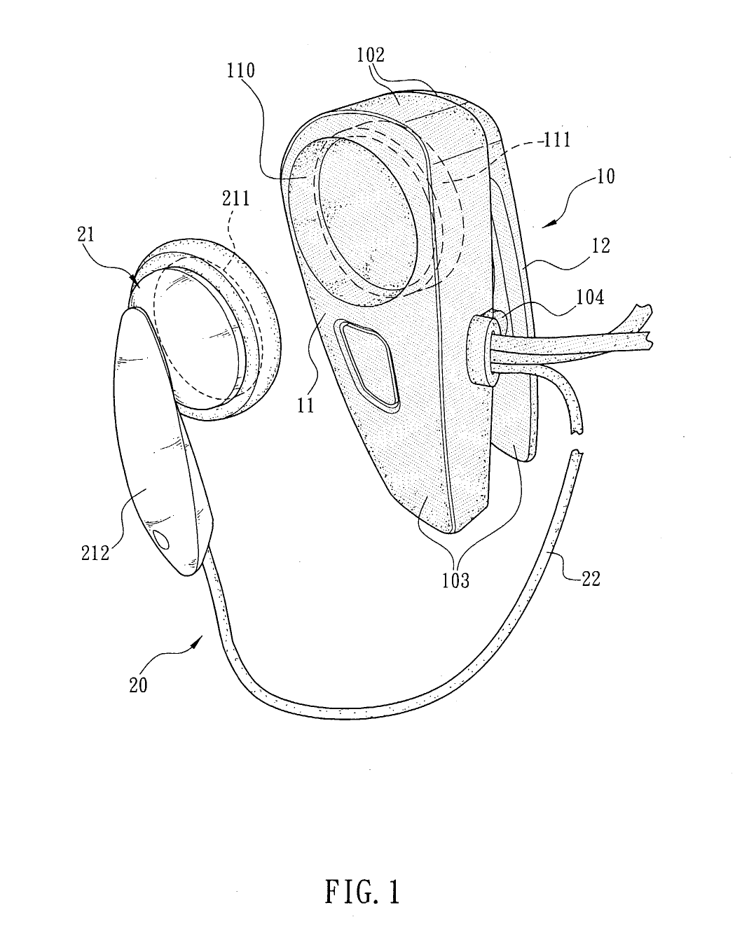

Referring to FIGS. 1, 2 and 3, there is shown an earphone 20 having a fastening device (e.g., clip) 10 in accordance with the invention. The clip 10 is formed at a cable 22 of the earphone 20. The earphone 20 comprises a receiver 21 having an internal speaker at one end with a metal grille 211 covered thereon and an elongate member 212 extended from the speaker in which sound can be outputted from the speaker to an ear 31 of a user 30 as the receiver 21 is inserted therein. The cable 22 is extended from the elongate member 212 of the earphone 20 to connect with the clip 10, and then extended from the clip 10 to form a jack (not shown) at the other open end. The jack is connectable to an electronic device (e.g., cellular phone or music player (not shown in the figures)) for achieving a hands-free purpose of the electronic device. Note that such jack and electronic device are known in the art. Thus a detailed description thereof is omitted herein for the sake of brevity.

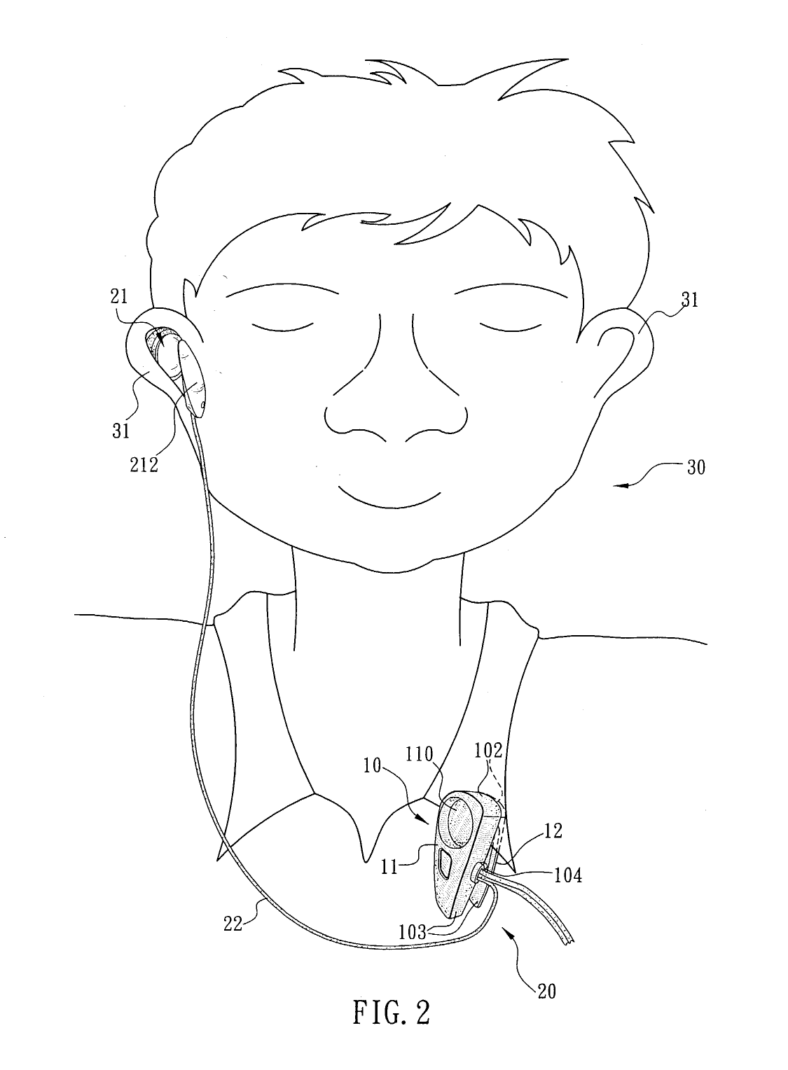

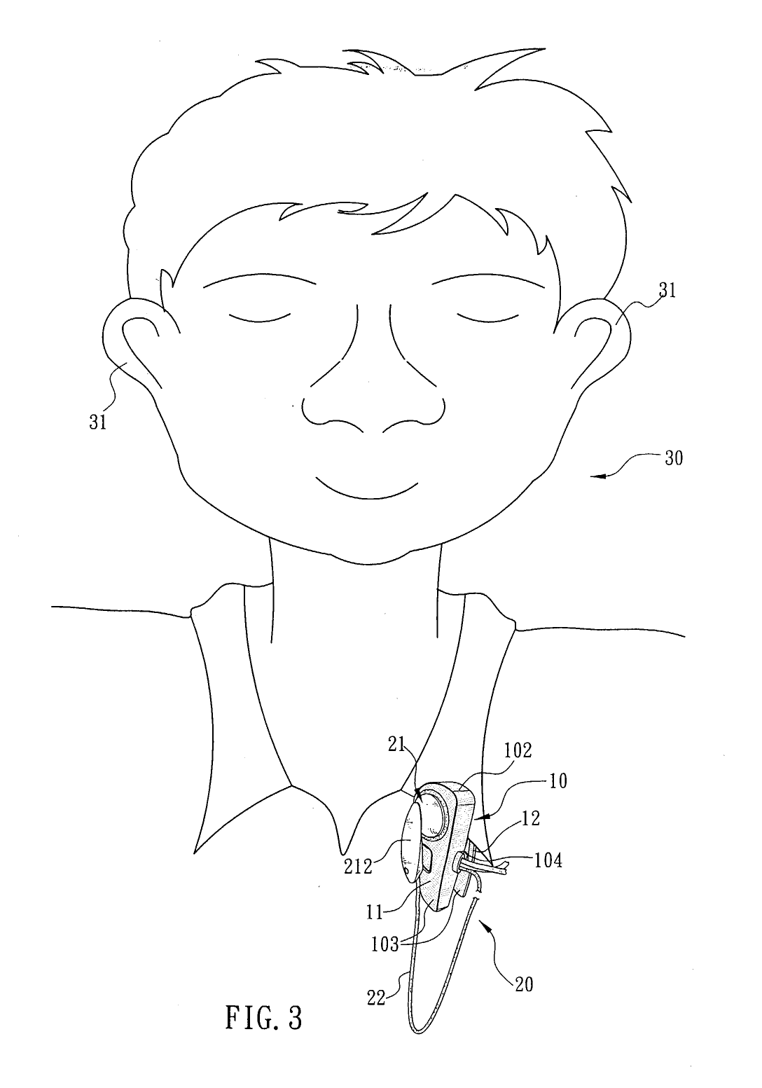

In the embodiment, the clip 10 comprises a first half member 11, a coupled second half member 12 each having a clipping end 102 at one end and a holding end 103 at the other end, and a central hinge 104 with a shaft (not shown) passing therethrough and a spring (not shown) put on the shaft, the spring having both ends urged against the first half member 11 and the second half member 12. In use, the user 30 can press the holding ends 103 toward each other to open the clipping ends 102 by means of leverage formed by the hinge 104 and the spring. An object such as clothes worn by the user 30 can be fastened by opening the clipping ends 102 (see FIGS. 2 and 3). This can achieve the purpose of securing the earphone 20 while moving.

Referring to FIGS. 1 and 3 specifically, the embodiment is characterized in that there are provided a recess 110 on a side of the first half member 11 adjacent the clipping end 102, the recess 110 being sized to permit the receiver 21 to fit therein, and a fastening element 111 on a bottom of the recess 110 for securing the receiver 21 in the recess 110. The fastening element 111 is implemented as a magnet in one configuration. The magnet is provided on the bottom of the recess 110 of the first half member 11 for magnetically attracting the metal grille 211 of the receiver 21. As a result, the receiver 21 can be stably adhered in the recess 110.

In another configuration the fastening element 111 is implemented as a plurality of latches (not shown) equally disposed around an inner edge of the recess 110. Thus, the receiver 21 can be secured in the recess 110 because a periphery of the receiver 21 is fastened by the latches.

By utilizing this, clothes worn on the user 30 can be secured to the clip 10 by clipping the clipping ends 102 of the clip 10 on the clothes (see FIG. 2). This enables the user 30 to listen sound or music from the earphone 20 in a hands-free manner in which the earphone 20 is electrically coupled to the electronic device. Further, in an unused state of the receiver 21 of the earphone 20, the user 30 can place the receiver 21 in the recess 110 of the first half member 11 for fastening the earphone 20 (see FIG. 3). This is an important fastening feature when the user 30 carries the earphone 20.

In brief, the invention can eliminate the drawbacks (e.g., the cable 22 and the receiver 21 falling and swaying on the user 30 in an unused state of the earphone 20, the thin conductor in the cable 22 broken due to an inadvertent pulling, a disconnection of the cable 22 (i.e., interrupt of sound), messy, not aesthetic, and not ergonomic) of the prior art.

What is claimed is:

1. A fastening device formed at a cable of an earphone including a receiver having an internal speaker at one end and a metal grille covered thereon, the cable being extended from the other end of the receiver to connect with the fastening device and then extended from the fastening device to form a jack at an open end thereof, the jack being connectable to an electronic device for receiving sound, the fastening device comprising:
a first half member including a clipping end at one end, a holding end at the other end and a central hinge disposed therebetween;
a coupled second half member including a clipping end at one, a holding end at the other end and a central hinge disposed therebetween; and
a shaft passing through the central hinges of the said two half members with a spring put on the shaft, the spring having both ends urged against the first half member and the second half member;
wherein the first half member further comprises a recess for fitting the receiver therein and a fastening element for securing the receiver in the recess.

2. The fastening device of claim 1, wherein the recess is formed on a side of the first half member adjacent the clipping end thereof.

3. The fastening device of claim 1, wherein the fastening element is a magnet provided on a bottom of the recess of the first half member for magnetically attracting the metal grille of the receiver so as to stably adhere the receiver in the recess.

4. The fastening device of claim 1, wherein the fastening element comprises a plurality of latches disposed around an inner edge of the recess for securing the receiver in the recess by fastening a periphery of the receiver by the latches.
